(19) United States
(12) Patent Application Publication
(10) Pub. No.: US 2026/0073114 A1
(43) Pub. Date: Mar. 12, 2026

(54) ILLUSTRATION GENERATOR FOR INTEGRATED CIRCUIT DESIGN AND METHOD

(71) Applicant: GlobalFoundries U.S. Inc., Malta, NY (US)

(72) Inventors: Simona Milenova Dimitrova, Sofia (BG); Aleks-Martin Konstantinov Lakovski, Sofia (BG); Mariya Bozhidarova Stanoeva, Sofia (BG); Romain H.A. Feuillette, Williston, VT (US); Stephen Trevor Burgess, Sofia (BG)

(21) Appl. No.: 18/827,682

(22) Filed: Sep. 7, 2024

(51) Int. Cl. G06F 30/392; G06F 111/20

(52) U.S. Cl. CPC G06F 30/392; G06F 2111/20

(57) ABSTRACT

Disclosed are a method, system, and software application (referred to herein as an illustration generator) for generating two or three dimensional (2D or 3D) digital illustrations of user-selected areas of integrated circuit (IC) layouts. The illustration generator can include a program of instructions executable by processor to cause the processor to perform a method. This method includes: generating a database of IC component regions (e.g., using a technology file, and a design manual); comparing a user-selected area of an IC layout to the database in order to identify specific IC component regions included within the user-selected area; and generating a 2D or 3D digital illustration of the area. The digital illustration can include representations of different structural features within the area including at least some of the previously identified specific integrated circuit component regions.

### BACKGROUND

The present disclosure relates to integrated circuit (IC) design and, more particularly, to an illustration generator for use in IC design and an associated method.

A digital illustration (also referred to herein as a digital rendering) of an IC under design or portion thereof can be employed by an IC designer, for example, when predicting performance (e.g., electrical behavior). However, currently available IC design software products typically enable rendering of only a single two-dimensional view at the device level and with exceptionally low granularity (e.g., showing only processing layers employed in forming a device without indicating layer height or device regions). Furthermore, the generated illustration is based only on the functions section of a technology file, at a fixed location through a device. Thus, the illustration has limited usefulness.

### SUMMARY

Disclosed herein are embodiments of a system and method employing an illustration generator for generating two-dimensional (2D) and/or three-dimensional (3D) digital illustrations of user-selected areas of integrated circuit (IC) layouts.

Disclosed herein are embodiments of a system for generating digital illustrations (e.g., two-dimensional (2D) and/or three-dimensional (3D) digital illustrations) of user-selected areas of integrated circuit (IC) layouts. Specifically, the system can include a processor and a storage medium, which is readable by the processor and stores a program of instructions executable by the processor to cause the processor to perform a method. This method includes generating a regions database using a technology file and a design manual. The method further includes comparing an area of an integrated circuit layout to the regions database to identify specific integrated circuit component regions within the area and then generating a digital illustration of the area including representations of the specific integrated circuit component regions.

Also disclosed herein are embodiments of a computer-implemented method for generating digital illustrations (e.g., two-dimensional (2D) and/or three-dimensional (3D) digital illustrations) of user-selected areas of integrated circuit (IC) layouts. The method includes generating, by a processor, a regions database using a technology file and a design manual. The method further includes comparing, by the processor, an area of an integrated circuit layout to the regions database to identify specific integrated circuit component regions within the area. The method further includes generating, by the processor, a digital illustration of the area including representations of the specific integrated circuit component regions.

Also disclosed herein are embodiments of a computer program product. The computer program product can include a computer readable storage medium having program instructions embodied therewith. The program instructions can be executable by a processor to cause the processor to perform the above-described method.

It should be noted that all aspects, examples, and features of disclosed embodiments mentioned in the summary above can be combined in any technically possible way. That is, two or more aspects of any of the disclosed embodiments, including those described in this summary section, may be combined to form implementations not specifically described herein. The details of one or more implementations are set forth in the accompanying drawings and the description below. Other features, objects and advantages will be apparent from the description and drawings, and from the claims.

### BRIEF DESCRIPTION OF THE DRAWINGS

The present disclosure will be better understood from the following detailed description with reference to the drawings, which are not necessarily drawn to scale and in which:

FIG. 1 is a flow diagram illustrating embodiments of a disclosed method for generating digital illustrations;

FIG. 2 is a schematic diagram illustrating embodiments of a disclosed system for generating digital illustrations;

FIG. 3 is a drawing showing an example screenshot of graphic user interface (GUI) of an illustration generator;

FIG. 4 is a flow diagram illustrating in greater detail a process of generating a regions database for use in digital illustration generation;

FIGS. 5-10 are drawings showing example screenshots of the graphic user interface (GUI) at different stages of digital illustration generation; and

FIG. 11 is a schematic diagram illustrating an example hardware environment for implementing aspects of the disclosed systems, methods and computer program products.

### DETAILED DESCRIPTION

As mentioned above, a digital illustration (also referred to herein as a digital rendering) of an IC under design or portion thereof can be employed by an IC designer, for example, when predicting performance (e.g., electrical behavior). However, currently available IC design software products typically enable rendering of only a single two-dimensional view at the device level and with exceptionally low granularity (e.g., showing only processing layers employed in forming a device without indicating layer height or device regions). Furthermore, the illustration is generated based only on the functions section of a technology file, at a fixed location through a device. Thus, the illustration has limited usefulness.

In view of the foregoing, disclosed herein are embodiments of a method, system, and software application (referred to herein as an illustration generator) for generating two-dimensional (2D) or three-dimensional (3D) digital illustrations of user-selected areas of integrated circuit (IC) layouts. The illustration generator can include a program of instructions executable by processor to cause the processor to perform a method. This method can include, but is not limited to: locally generating a regions database (e.g., using, as inputs, a technology file for a specific processing technology and a design manual); comparing a user-selected area of the IC layout to the regions database in order to identify specific IC component regions included within the user-selected area; and generating a digital illustration of the area including representations of the specific IC component regions. In some embodiments, the digital illustration can be 2D. In some embodiments, the digital illustration can be 3D. In some embodiments, the user can select between 2D and 3D digital illustrations. For a 2D digital illustration, the GUI of the illustration generator can allow the user to place a line over the IC layout at a desired location to define the illustration area. For a 3D digital illustration, the GUI of the illustration generator can allow the user to place a 2D polygon shape (e.g., a parallelogram shape, such as a rectangle, or some other polygon shape) over the IC layout at a desired location to define the illustration area. Optionally, the GUI of the illustration generator can further allow the user to select specific regions to be shown in the digital illustration and to select a specific region for which the region height is to be indicated in the digital illustration. In any case, the digital illustration can include representations of different structural features within the area including at least some of the previously identified specific integrated circuit component regions (e.g., depending upon layer selection) and, optionally, dielectric material regions adjacent thereto. Thus, the digital illustration can show the area with a relatively high level of granularity. For an IC design including the IC layout, performance can be predicted using these digital illustration(s) along with other tools (e.g., parasitic extraction tools) and the IC design can be modified as necessary to ensure performance specifications are met, prior to release of the final IC design to tape-out and manufacturing.

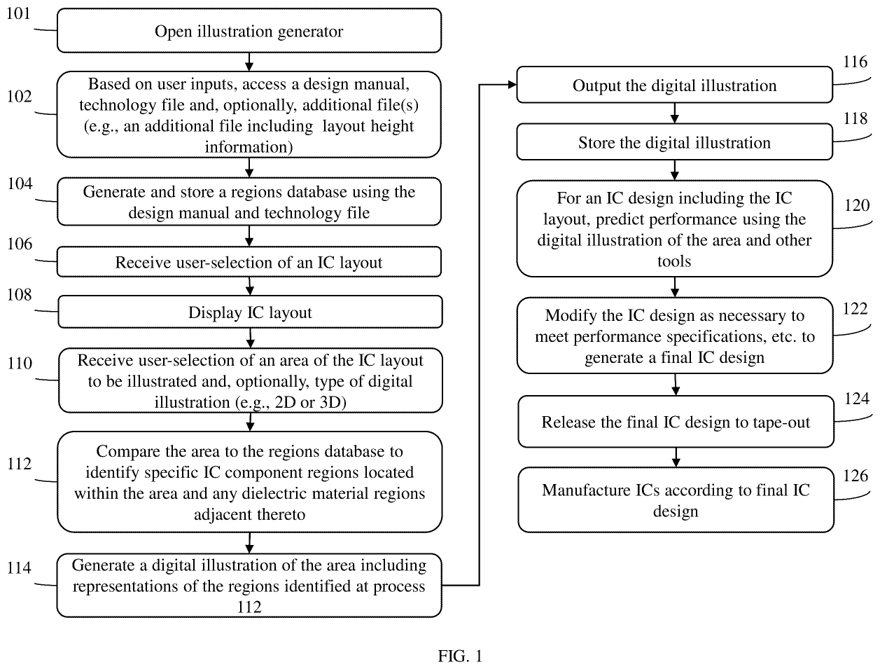

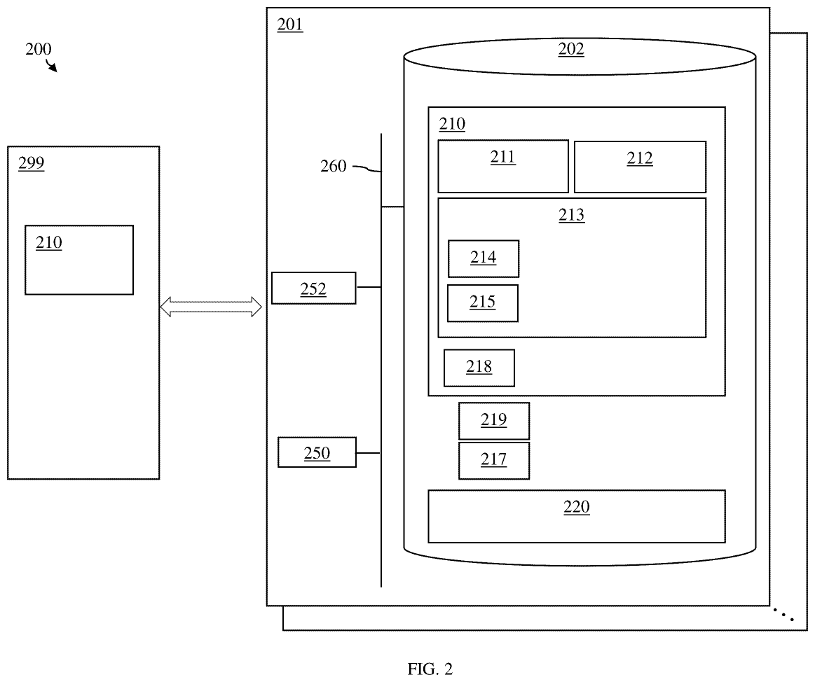

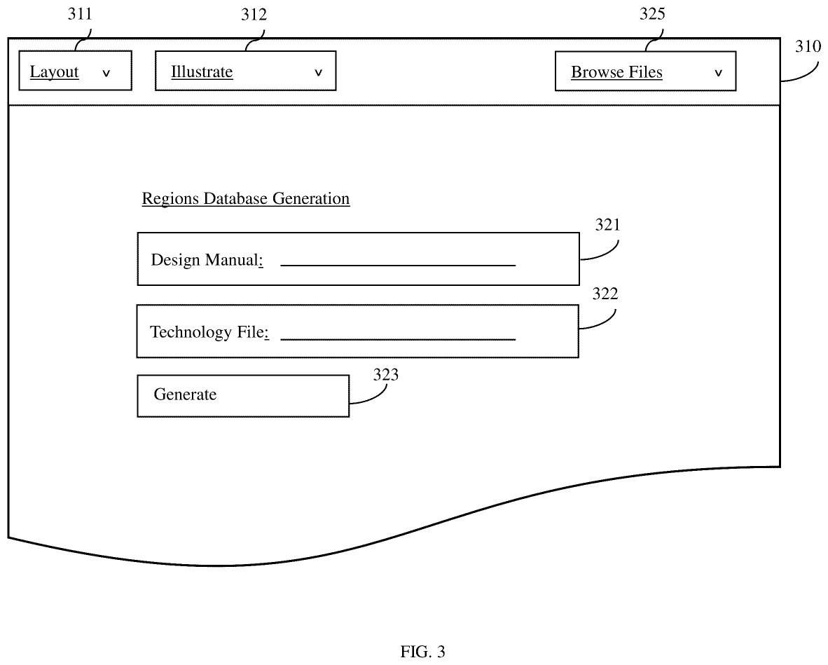

FIG. 1 is a flow diagram illustrating disclosed embodiments of integrated circuit (IC) design and manufacturing methods including generation of dimensional (2D) or three-dimensional (3D) digital illustrations of user-selected areas of integrated circuit (IC) layouts for use, for example, in predicting IC performance during design. FIG. 2 is a schematic diagram illustrating an IC design environment 200 within which the disclosed embodiments can be implemented.

Referring to FIG. 2, IC design environment 200 can include a foundry computer system 299. The foundry computer system 299 can be configured for development, revisioning, etc., of a process design kit (PDK) 210. PDK 210 can be associated with a specific processing technology supported by the semiconductor foundry (also referred to herein as a technology node or process node). Those skilled in the art will recognize that a technology node is typically identified in nanometers (e.g., a 45 nm, 32 nm, 22 nm, 14 nm, etc.), thereby indicating the size of the semiconductor features that can be formed on a semiconductor wafer at the foundry using the technology. The technology node may also indicate the type of wafer, such as a silicon-on-insulator (SOI) wafer (e.g., 45 nm SOI, 32 nm SOI, 22 nm SOI, etc.), bulk silicon wafer, etc. With different technology nodes there are different circuit architectures. As discussed in greater detail below, PDK 210 can include conventional PDK components as well as a novel illustration generator 218, as disclosed herein, to aid in IC design.

IC design environment 200 can also include one or more CAD system(s) 201 (e.g., of customer(s) of the semiconductor foundry and, particularly IC designers (referred to herein as user(s))). Each CAD system 201 can be configured to use PDK 210 in conjunction with local electronic design automation (EDA) tools 220 to generate IC designs. An IC design can be generated, modified, and finalized by a user using PDK 210 and EDA tools 220. Once finalized, an IC design can be forwarded to the semiconductor foundry, released to tape-out, and subsequently manufactured by the semiconductor foundry according to the design. PDK-based design improves yield during manufacturing because the PDK is foundry-specific and accounts for process variations.

More particularly, CAD system 201 can include at least one processor 250, at least one display 252, and at least one computer readable storage medium 202 readable by processor(s) 250. The various components of CAD system 201 including, but not limited to, processor(s) 250, display(s) 252, and storage medium(s) 202 can be interconnected over a system bus 260, as illustrated, and/or over a wired or wireless network (not shown). Furthermore, the various components of computer system 201 can be co-located. Alternatively, CAD system 201 can be a client-server system with a central server and multiple networked workstations. Alternatively, CAD system 201 can be a distributed system whose components are distributed across different networked computers. In any case, for purposes of illustration, CAD system 201 is illustrated in FIG. 2 and described below as if it incorporates only a single processor 250, a single display 252, and a single storage medium 202. However, it should be understood that, alternatively, CAD system 201 can incorporate any number of one or more processors 250 for performing one or more of the different steps in the disclosed method, any number of one or more displays 252, and any number of one or more storage mediums for storing the data and tools that are employed in the disclosed method.

Storage medium 202 can store EDA tools 220 (also referred to herein as EDA programs or applications). EDA tools 220 can include programs of instruction, which are executable by processor(s) 250 during different stages in a design flow (e.g., during cell selection and customization (if applicable), schematics generation, floorplanning, power planning, I/O pin placement, cell placement, clock planning wire routing, layout versus schematic (LVS) checking, design rule checking, simulations, etc.). EDA tools 220 are well known in the art. Thus, the details thereof have been omitted from this specification in order to allow the reader to focus on the salient aspects of the disclosed embodiments.

PDK 210 can be accessible by CAD system 201. For example, PDK 210 could be downloaded from the foundry computer system 299 (e.g., via an electronic communications network) and stored on storage medium 202 (as illustrated). Alternatively, PDK 210 could be provided to a customer on a non-transitory computer readable storage medium or device (e.g., a disk, flash drive, portable hard drive, etc.). In this case, the PDK 210 could be accessible by processor 250 of CAD system through some interface (e.g., via a disk reader, USB port, or other interface, as appropriate) or uploaded from the device to CAD system 201 and stored on storage medium 202.

As mentioned above, PDK 210 can include conventional PDK components. These conventional PDK components can include, but are not limited to, one or more cell libraries 211 (e.g., a parameterized cell library and/or a standard cell library), a graphic user interface (GUI) 212, other design data and files 213, etc. Files 213 can include, but are not limited to, schematic symbols and component description format (CDF) descriptions, simulations and callbacks, models, a technology file 214, a design manual (DM) 215 (also referred to in the art as a design rule manual (DRM)), a mapping file, etc. Technology file 214 will typically include information regarding processing layers in a specific processing technology and physical and electrical characteristics of such layers (e.g., the logical and physical mask layers, material properties, description of layer stacks, etc.). Design manual 215 can include a text document, which provides a description of the processing technology including, but not limited to, design rules (also referred to as layout rules) and technology node design requirements, a glossary of design rule terminology, a table of mask layers, and a truth table. Those skilled in the art will recognize that design rules refer, for example, to minimum layout dimensions (e.g., for shapes, for spaces between shapes, for enclosures, etc.) that will meet process and electrical parameter specifications. That is, design rules are written to verify shapes and sizes of various IC component regions that can be formed on a semiconductor wafer using the various processing layers (e.g., created, for example, by diffusion, implantation, patterning, etc.).

In addition to conventional PDK components, PDK 210 can include an illustration generator 218. Illustration generator 218 can be a software application including a program of instructions executable by processor 250 to cause processor 250 to perform a method for generating a digital illustration of a user-selected area of an IC layout. Specifically, the method can include processes 101-120 of the flow diagram of FIG. 1, described in greater detail below.

Referring to FIGS. 1-2 in combination, in the disclosed embodiments illustration generator 218 can be opened (e.g., in response to user inputs) and a GUI 212 therefore can be displayed on a display 252 (see process 101). FIG. 3 is a drawing showing an example screenshot of GUI 212 upon opening of illustration generator 218. As illustrated, GUI 212 can include a tool bar 310. Tool bar 310 can include drop down menus 311-312 or any other suitable means for allowing a user to access various tools and files, and to make user-selections during illustration generation (see process 102).

For example, at process 102, a user can be automatically prompted to select both a design manual 215 and a technology file 214 for access by illustration generator 218. For example, GUI 212 can present the user with prompts 321-322 for entering paths to the design manual 215 and technology file 214 stored in storage medium 202. Alternatively, tool bar 310 could provide some other means by which a user could select design manual 215 and technology file 214 and make them accessible by illustration generator 218. Tool bar 310 may further provide a user with a means of accessing and selecting one or more additional files 325. Additional files 325 could include, for example, files containing additional information, which is not otherwise contained in the design manual or technology file and which could be accessed and, optionally, displayed along with a subsequently generated illustration. For example, one such additional file 325 could contain height information for each of the processing layers in a particular processing technology.

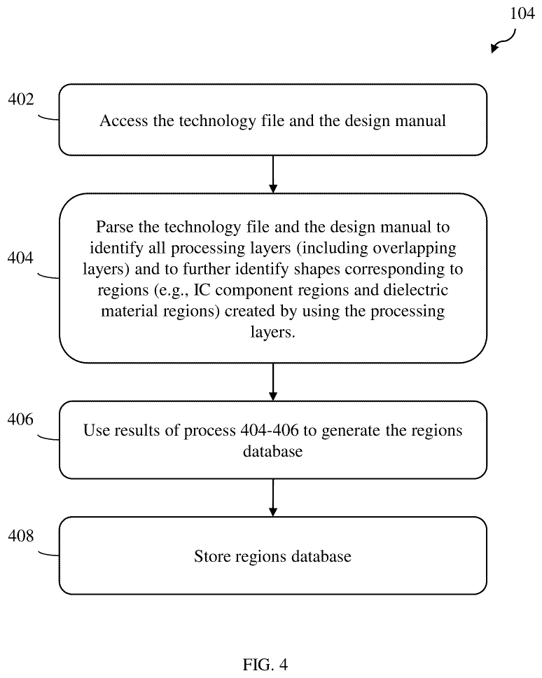

In any case, illustration generator 218 can generate a regions database 219 using design manual 215 and technology file 214. Such a regions database 219 can be generated automatically or on demand (e.g., via pressing a generate button 323 or the like on GUI 212). More particularly, technology file 214 and DM 215 can be employed as inputs for generation of regions database 219 (see process 104). FIG. 4 is a flow diagram illustrating in greater detail process 104 of FIG. 1.

Referring to FIG. 4 in combination with FIG. 2, technology file 214 and DM 215 can be accessed (see process 402). Technology file 214 and DM 215 can further be parsed to identify all processing layers including any overlapping layers, to identify the visual identifiers used for high lighting and distinguishing the different processing layers in IC layouts, and to further identify shapes corresponding to IC component regions and dielectric material regions created using those processing layers (see process 404). For example, based on the processing layers identified in the technology file 214 and the glossary of design rule terminology and the truth table of DM 215, information can be acquired about shapes that can be placed in IC layouts and dependency of each shape on other shapes (e.g., on overlapping layers). It should be noted that the visual identifiers mentioned above can be different fill colors, different fill patterns, different line colors, different line weights, different line dash patterns and/or any other possible graphic design option for distinguishing different regions.

Regions database 219 can then be created based on the information acquired at process 404 (see process 406). Regions database 219 can include a list of IC component regions and dielectric material regions that could be formed using the processing technology and the processing layer(s) that create those IC component regions (see process 408). Regions database 219 can also associate these IC component regions with additional information including, but not limited to, unique visual identifiers. In any case, regions database 219 can identify, by name, IC component and dielectric material regions (e.g., of a particular device formed using the processing technology of the PDK). For example, regions database 219 can identify, by name: the gate, source, drain, channel, etc. of PFET1; the gate, source, drain, etc. of PFET2; the gate, source, drain, channel, etc. of NFET1; the base, emitter, collector, etc. of NPN transistor1; the base, emitter, collector, etc. of PNP transistor1; and so on. Regions database 219 can further include additional information associated with each named IC component region including, but not limited to, processing layer or overlapping processing layers used to form the IC component region.

For example, consider a PFET1. Processing layers used in the formation of a PFET1 can include a substrate, an N-type well layer (NW) within (i.e., overlapping) the substrate, an active device layer (RX) over NW, P-type diffusion layer (PPLUS) within (i.e., overlapping) RX, a gate conductor layer (also referred to as a gate polysilicon layer) (PC) over RX, etc. The named IC component regions of PFET1 can include a gate, source, drain, channel, etc. Therefore, within regions database 219, named IC component regions of PFET1 can be associated with the following processing layer(s). Channel region of PFET1 can be associated with RX only. Source and drain of PFET1 can each be associated with overlapping layers including patterned PPLUS features within the patterned RX feature. A dielectric material region (e.g., a shallow trench isolation (STI) structures) can laterally surround the patterned RX feature. Gate of PFET1 can be associated with a patterned PC feature, which is above the channel region within RX and which further extends onto the STI structure adjacent to RX. Additional IC component regions of PFET1 could include, for example: middle of the line (MOL) contacts associated with MOL contact; back end of the line (BEOL) wires associated with BEOL metal levels (including metal layers M1-Mx and via layers therebetween), etc.

Regions database 219 can then be stored in storage medium 202 (see process 408).

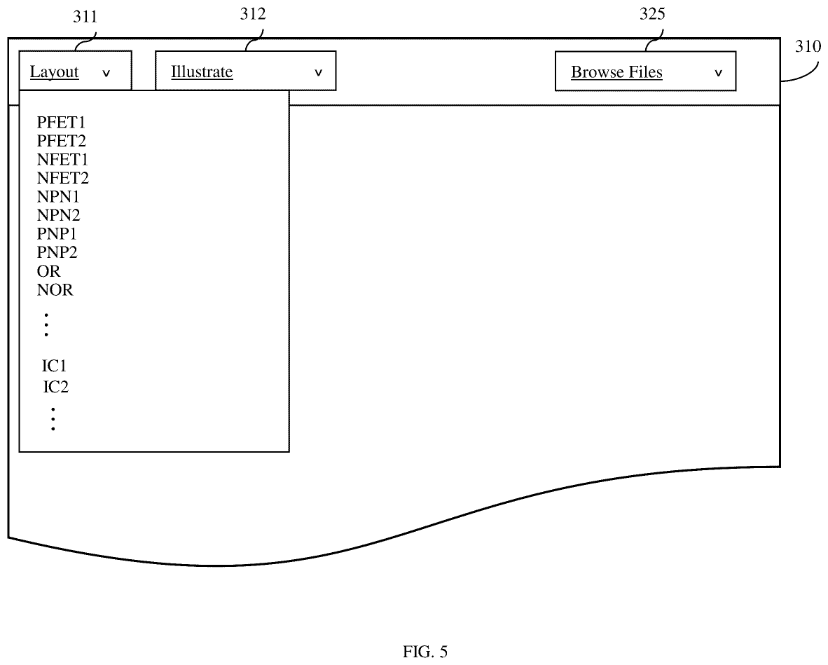

Referring again to FIGS. 1-2 in combination, user-selection of a specific IC layout can subsequently be received via GUI 212 (see process 106). For example, tool bar 310 can include a drop down menu 311 or the like to facilitate selection of an IC layout from a list of one or more IC layout files. FIG. 5 is a drawing showing an example screenshot of GUI 212 upon selection of layout drop down menu 311. Layouts available for selection through drop down menu 311 could include an entire IC (e.g., IC1, IC2, etc.). Additionally, layouts available for selection through drop down menu 311 could include single devices. A single device could be specific type of device (e.g., a P-type field effect transistor (PFET), an N-type field effect transistor (NFET), an NPN bipolar junction transistor, a PNP bipolar junction transistor, a capacitor, etc.) with a particular configuration. Layouts available for selection through drop down menu 311 could be for small or large groups of interconnected devices such as a logic gate (e.g., an OR gate, a NOR gate, an AND gate, etc.) or some other group of interconnected devices. Thus, as illustrated, the list of layouts on drop down menu 311 could include any of one or more different PFETs (i.e., PFET1, PFET2, PFET3, etc.), one or more different NFETs, logic gates, entire ICs, etc.

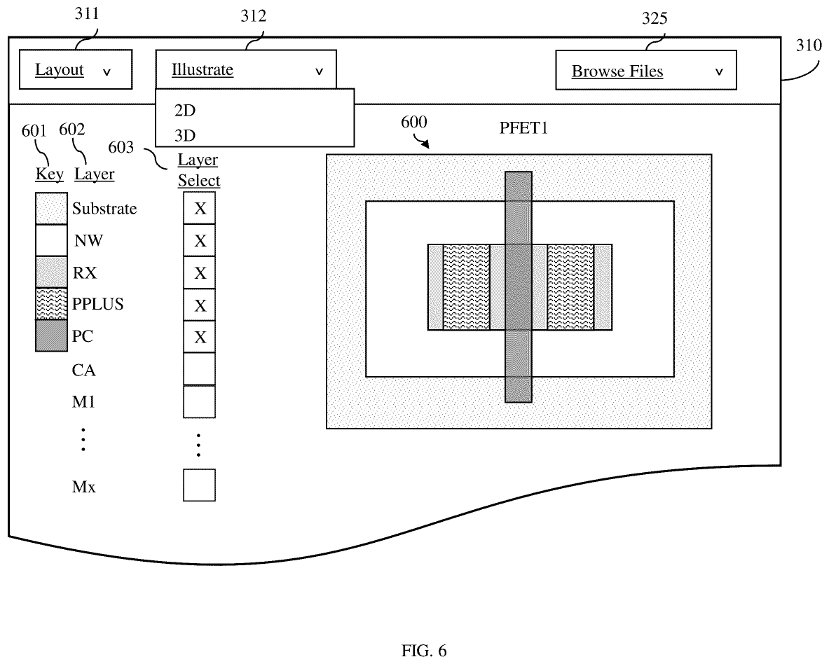

Once a specific IC layout is selected, it can be displayed via GUI 212 (see process 108). FIG. 6 is a drawing showing an example screenshot of GUI 212 displaying a user-selected IC layout 600 (hereinafter referred to as IC layout 600) for PFET1. Optionally, IC layout 600 can be displayed along with a key 601 of visual identifiers (e.g., colors, patterns, etc.) employed for the different processing layers 602 in the IC layout 600. Also, optionally, selection buttons 603 or the like can further be included on the GUI 212 to allow for user-selection or user-deselection of individual processing layers to include or exclude such layers from the displayed IC layout 600. It should be noted that dielectric material is not depicted in a displayed IC layout.

Referring again to FIG. 1, the method can further include receiving selection inputs from a user and, particularly, an input indicating an area of IC layout 600 to be illustrated and, optionally, an input indicating the requested type of digital illustration (i.e., a request to generate a 2D digital illustration and/or 3D digital illustration of the area) (see process 110). The area of the IC layout can be compared to regions database 219 to identify specific IC component regions within the area as well as any dielectric material regions adjacent to those specific IC component regions (see process 112). Then, the 2D and/or 3D digital illustration of the area can be generated such that it includes representations of the regions identified at process 112 (i.e., the specific IC component regions in the user-selected area of the IC layout and any dielectric material regions adjacent to those specific IC component regions) (see process 114). Once generated, the digital illustration can be output for review by the user (see process 116). For example, at process 116, the digital illustration can be displayed through GUI 212 (as discussed in greater detail below). Additionally, or alternatively, the digital illustration could, at process 116, be printed, emailed, messaged, etc. or otherwise output for user review.

More specifically, in some embodiments, illustration generator 218 can be configured to generate 2D digital illustrations only. In some embodiments, illustration generator 218 can be configured to generate 3D digital illustrations only. In some embodiments, illustration generator 218 can be configured to allow the user to select between generation of a 2D digital illustration or a 3D digital illustration. An embodiment that allows for user-selection of either a 2D digital illustration or a 3D digital illustration is described below. In this case, tool bar 310 can further include a drop down menu 312 or the like to facilitate user selection of either a 2D or 3D (e.g., see FIG. 6, which is a drawing of an example screenshot of GUI 212 displaying drop down menu 312 in FIG. 6).

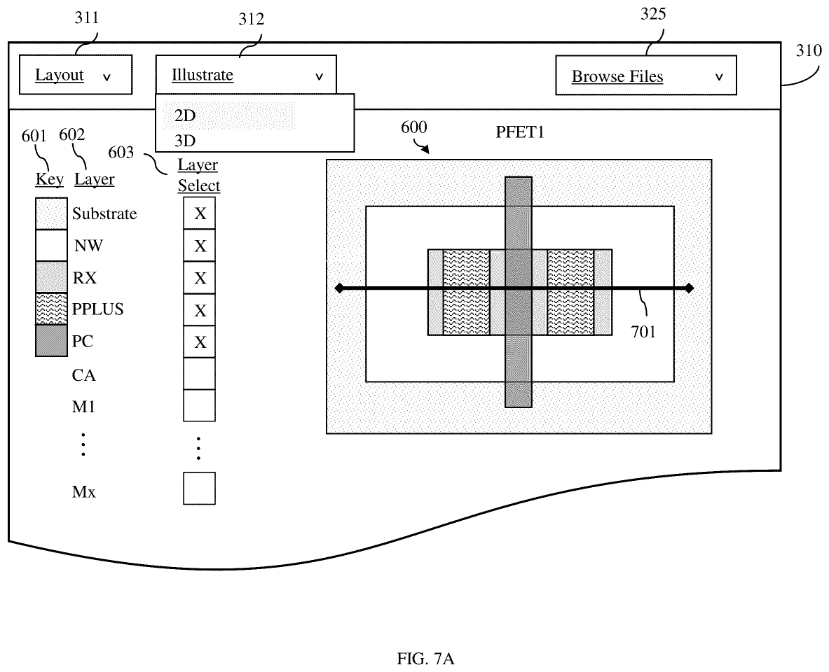

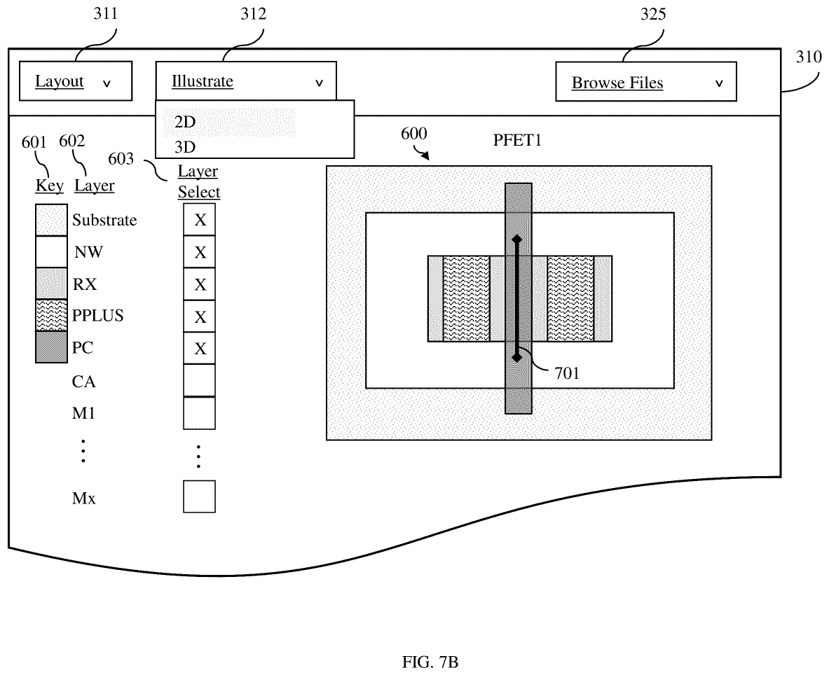

For a 2D digital illustration, GUI 212 can allow the user to place a line anywhere over IC layout 600 at a desired location to define the illustration area. For example, FIG. 7A is a drawing showing an example screenshot of GUI 212 including a line 701 placed by a user horizontally (i.e., in the X direction) over IC layout 600, along the center of the device (e.g., across the full length of the device). FIG. 7B is drawing showing an example screenshot of GUI 212 including a line 701 placed by a user vertically (i.e., in the Y direction) over IC layout 600, along the center of the device (e.g., across the full width of the device). As illustrated in FIGS. 7A and 7B, the length and orientation of line 701 can be user-defined to indicate different areas of IC layout 600 to be illustrated. Furthermore, FIGS. 7A and 7B are not intended to be limiting. For example, alternatively, line 701 could be oriented diagonally, could only partially traverse the device, could be placed off-center, etc. By adjusting the length, placement, and orientation of line 701, any given area (large or small) of the layout could be defined. It should be understood that placement of line 701 can be performed by a user using conventional line placement, size adjustment, and rotation adjustment tools available through GUI 212. Once such a line 701 has been placed (at process 110), the area defined by the line 701 can be compared to regions database 219 to identify the specific IC component regions that are located within that area as well as any dielectric material regions adjacent to those specific IC component regions (at process 112). Then, a 2D digital illustration of the area can be generated such that it includes representations of the regions identified at process 112 (see process 114) and can further be displayed through GUI 212. Generation and display of the 2D digital illustration can be performed automatically upon placement of line 701 or on-demand (i.e., in response to a user command).

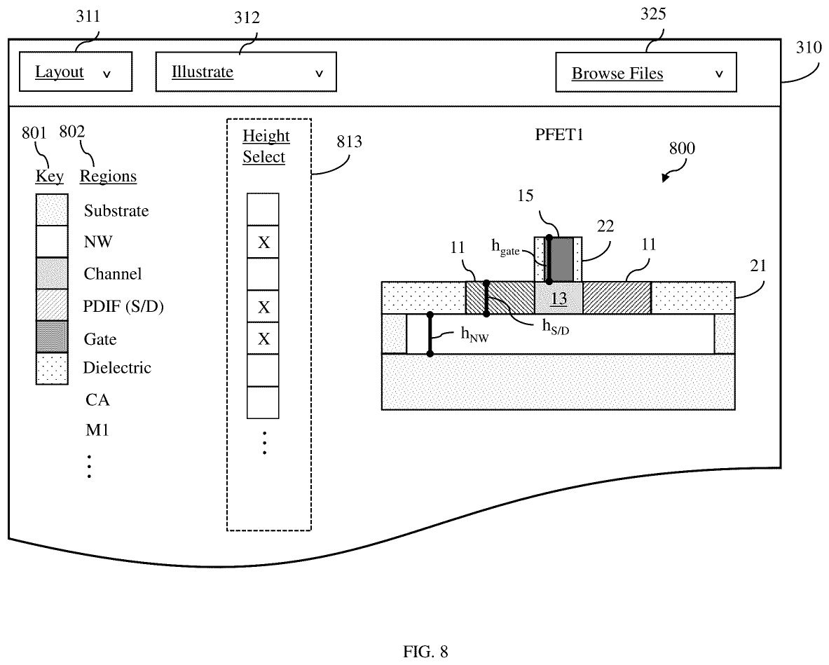

FIG. 8 is a drawing showing an example screenshot of GUI 212 displaying a 2D digital illustration 800 of the area of the IC layout 600, which was generated by illustration generator 218 in response to placement of a line 701 over IC layout 600, as shown in FIG. 7A. Optionally, 2D digital illustration 800 can be displayed along with a key 801 of visual identifiers (e.g., colors, patterns, etc.) employed for the different IC regions 802 including dielectric material regions. Also, optionally, selection buttons 813 or the like can further be included on the GUI 212 to allow for user-selection of region heights to be displayed. In this example, the 2D digital illustration 800 of PFET1 includes representations of the following IC component regions: a substrate; an Nwell in the substrate; above the Nwell, a channel 13 positioned laterally between source/drain regions 11 (i.e., p-type diffusion regions (PDIF)); and a gate structure 15 on channel region 13. The 2D digital illustration 800 of PFET1 also include representations of the following dielectric material regions including, for example: STI structures 21 positioned laterally adjacent to source/drain regions 11; and gate sidewall spacers 22 positioned laterally adjacent to gate structure 15.

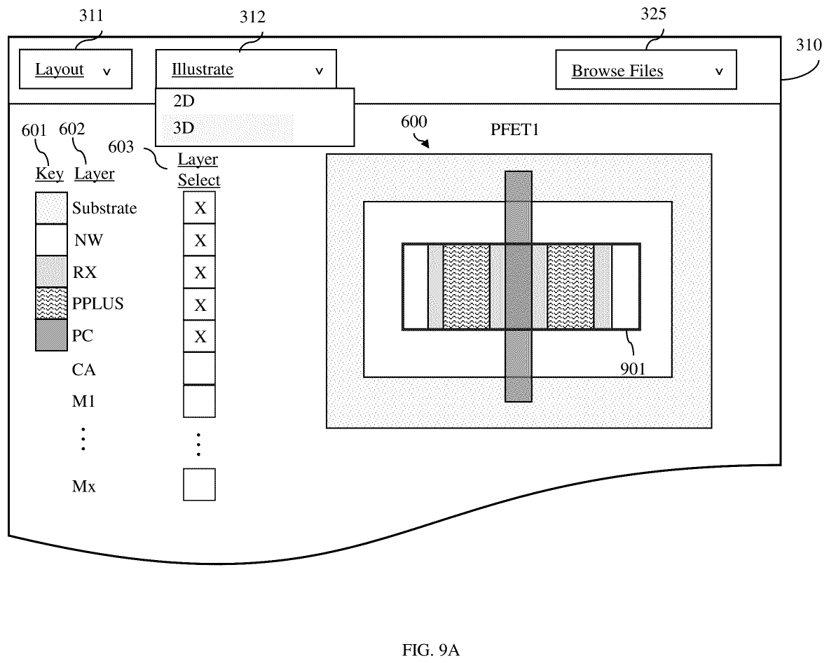

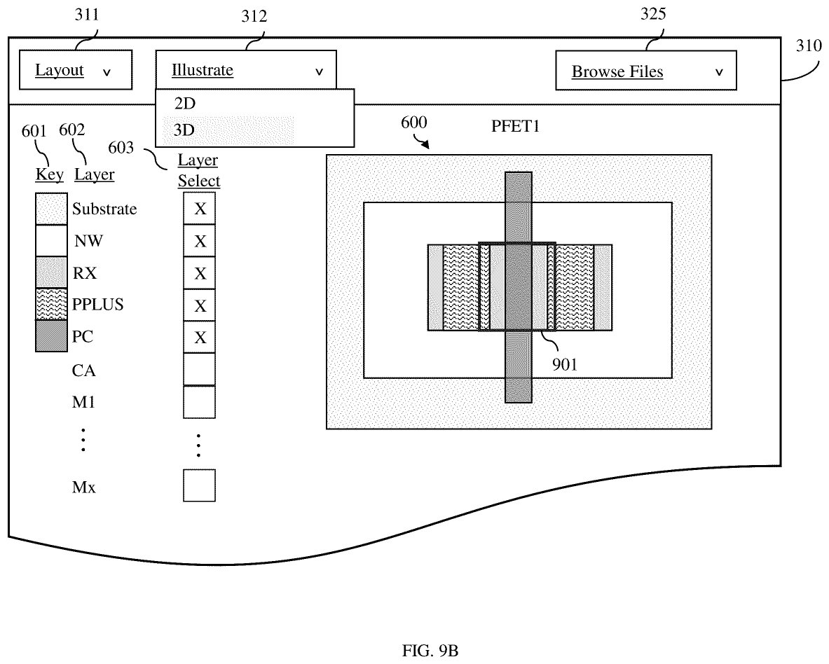

For a 3D digital illustration, GUI 212 can allow the user to place a polygon shape anywhere over IC layout 600 at a desired location to define the illustration area. The polygon shape could be, for example, a parallelogram shape, such as a rectangle, or some other polygon shape. For example, FIG. 9A is a drawing showing an example screenshot of GUI 212 including a rectangle shape 901 over IC layout 600, across the full length and width of the device. FIG. 9B is a drawing showing an example screenshot of GUI 212 including a rectangle shape 901 placed across a smaller area than shown in FIG. 9A. Furthermore, FIGS. 9A-9B are not intended to be limiting. For example, alternatively, polygon shapes 901 could be some shape other than a rectangle, could be oriented diagonally, could only partially traverse the device, could be placed off-center, etc. By adjusting the shape, size, placement, and orientation of polygon 901, any given area (large or small) of the layout could be defined. It should be understood that placement of polygon shape 901 can be performed by a user using conventional shape placement, size adjustment, and rotation adjustment tools available through GUI 212. Once such a polygon shape 901 has been placed (at process 110), the area defined by the polygon shape 901 can be compared to regions database 219 to identify the specific IC component regions that are located within that area as well as any dielectric material regions adjacent to those specific IC component regions (at process 112). Then, a 3D digital illustration of the area can be generated such that it includes representations of the regions identified at process 112 (see process 114) and can further be displayed through GUI 212. Generation and display of the 3D digital illustration can be performed automatically upon placement of polygon shape 901 or on-demand (i.e., in response to a user command).

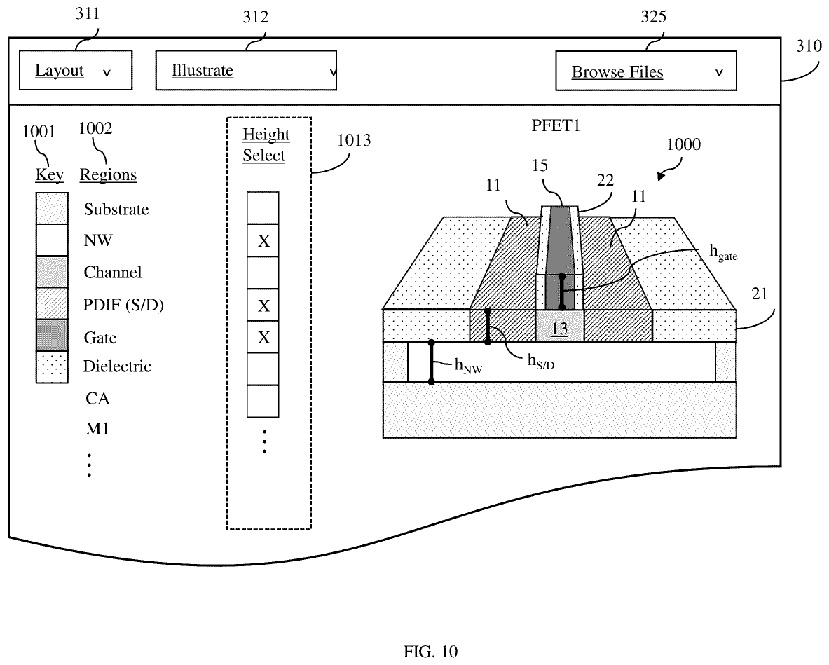

FIG. 10 is a drawing showing an example screenshot of GUI 212 displaying a 3D digital illustration 1000 of the area of the IC layout 600, which was generated by illustration generator 218 in response to placement of a rectangle shape 901 over IC layout 600, as shown in FIG. 9A. Optionally, 3D digital illustration 1000 can be displayed along with a key 1001 of visual identifiers (e.g., colors, patterns, etc.) employed for the different IC regions 1002 including dielectric material regions. Also, optionally, selection buttons 1013 or the like can further be included on the GUI 212 to allow for user-selection of region heights to be displayed. In this example, the 3D digital illustration 1000 of PFET1 includes representations of the following IC component regions: a substrate; an Nwell in the substrate; above the Nwell, a channel 13 positioned laterally between source/drain regions 11 (i.e., p-type diffusion regions (PDIF)); and a gate structure 15 on channel region 13. The 3D digital illustration 1000 of PFET1 also include representations of the following dielectric material regions including, for example: STI structures 21 positioned laterally adjacent to source/drain regions 11; and gate sidewall spacers 22 positioned laterally adjacent to gate structure 15.

As mentioned above, optionally, selection buttons 603 or the like can further be included on GUI 212 to allow for user selection or user deselection of individual processing layers for inclusion in or exclusion from the displayed processing layers of an IC layout. Although not shown, similar selection buttons can also be included in GUI 212 to allow for user selection or user deselection of regions at process 114. Additionally, although processing layers are not shown in the example 2D digital illustration 800 of FIG. 8 or the example 3D digital illustration 1000 of FIG. 10, optionally GUI 212 can further be configured so that processing layer information for each region illustrated therein could be displayed on demand. For example, the processing layer(s) for a given region could be named in a pop-up window when a user scrolls over the region in the list or in the illustration itself, when a user clicks on the region in the list or in the illustration itself, etc.

Optionally, as illustrated in FIGS. 8 and 10, selection buttons 813, 1013 or the like can further be included on GUI 212 to allow for user selection or user deselection of the heights of individual regions. It should be noted that this region height information can be automatically determined based on layer height information contained in an additional file containing such information (e.g., if such a file is selected at process 102). If layer height information is not available (e.g., if layer height information is considered confidential and accessed to any additional file(s) containing information is blocked), then default values for region heights could be displayed upon selection. For example, as illustrated in FIGS. 8 and 10, heights for the NW, S/D(s) and gate(s) of PFET1 can be selected and included in digital illustrations 800, 1000, whereas all other region heights are deselected and, thus, excluded. Alternatively, if regions database 219 includes region height information, the region height information could be embedded in the digital illustrations 800, 1000 for all regions and only visible on-demand (e.g., when a user scrolls over or clicks on a particular region).

As mentioned above, length, orientation, and location of line 701 placed over an IC layout or shape, size, orientation and location of polygon 901 placed over an IC layout can be varied. As a result, if a layout with only a single device has been selected at process 106 for processing, the entire device or only a portion thereof could be selected for inclusion in the resulting digital illustration generated at process 114. Furthermore, if a layout with multiple devices (e.g., a layout of an entire IC, a layout of a group of interconnected devices, such as a logic gate, etc.) has been selected for processing at process 106, all of the devices or only a portion thereof could be selected for inclusion in the resulting digital illustration generated at process 114.

Referring again to FIG. 1, a digital illustration generated at process 114 can also be stored (e.g., in an illustrations database 217) on storage medium 202 (see process 118). Using the techniques described above, multiple different digital illustrations of different areas of the same IC layout could be generated, output (e.g., displayed, etc.), and stored in illustrations database 217. Additionally, multiple different digital illustrations of different areas of different IC layouts could be generated, output (e.g., displayed, etc.), and stored in illustrations database 217.

For an IC under design that includes IC layout(s) with area(s) represented by digital illustration(s) stored in illustrations database 217, IC performance can be predicted using the digital illustration(s) along with other EDA tools (e.g., parasitic extraction tools, simulators, etc.) (see process 120). When the predicted performance does not meet performance requirements, the IC design can be modified, as necessary (see process 122). Once the IC design meets performance requirement, the final IC design can be released to tape-out and ICs can subsequently be manufactured according to the final IC design (see processes 124-126).

By employing such 2D or 3D digital illustrations to aid in predicting IC performance, a user will have a more accurate, detailed view of devices included in the IC design and a better understanding of their electrical behaviors and interactions. Thus, a user will need to make fewer best guesses about the electrical impact that a change in an IC design will have on the various regions within the IC design. As a result, an IC design in this manner (e.g., using digital illustrations generated by illustration generator 218) may proceed to tape out more quickly and will generally have improved yield during manufacturing because, for example, parasitic extractions and simulations will be perform based on a 2D or 3D digital illustration with a higher granularity than a simple IC layout.

Embodiments disclosed herein may be implemented as a computer system, a computer-implemented method, and/or a computer program product. The computer program product may include a computer readable storage medium (or media) having computer readable program instructions thereon for causing a processor to carry out aspects of the disclosed embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device

Computer readable program instructions for carrying out operations of the disclosed embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed embodiments.

Aspects of the disclosed embodiments are described herein with reference to flowchart illustrations and/or block diagrams of methods, apparatus (systems), and computer program products according to disclosed embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various disclosed embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

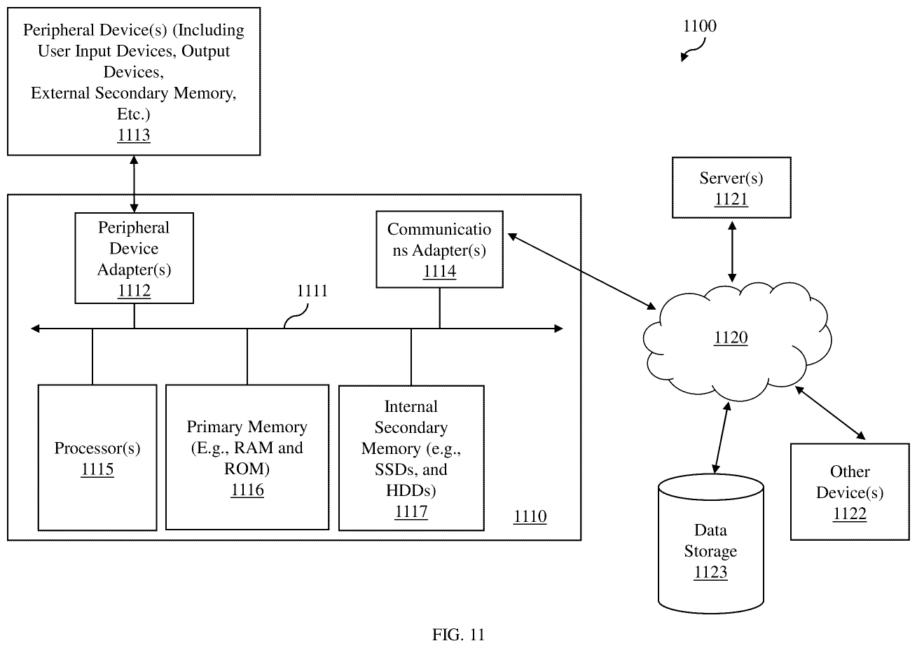

An exemplary hardware environment 1100 (i.e., computer system) for implementing aspects of the disclosed systems, methods and computer program products is depicted in FIG. 11. Generally, the hardware environment can include at least one computer 1110. Computer 1110 can be, for example, a desktop, laptop, tablet, mobile computing device, etc. Computer 1110 can include at least one bus 1111. Bus 1111 can be connected to various other components of computer 1110 and can be configured to facilitate communication between those components.

Computer 1110 can include various adapters. The adapters can include one or more peripheral device adapters 1112, which are configured to facilitate communications between one or more peripheral devices 1113, respectively, and the bus 1111. Peripheral devices 1113 can include user input devices configured to receive user inputs. User input devices can include, but are not limited to, a keyboard, a mouse, a microphone, a touchpad, a touchscreen, a stylus, bio-sensor, a scanner, or any other type of user input device. Peripheral devices 1113 can also include additional input devices, such as external secondary memory devices (as discussed in greater detail below). Peripheral devices 1113 can also include output devices. The output devices can include, but are not limited to, a printer, a monitor, a speaker, or any other type of computer output device. The adapters can include one or more communications adapters 1114 (also referred to herein as a computer network adapters), which are configured to facilitate communications between computer 1110 and one or more communications networks 1120 (e.g., a wide area network (WAN), a local area network (LAN), the internet, a cellular network, a Wi-Fi network, etc.). Such network(s) 1120 can, in turn, facilitate communications between computer 10 and other system components on the network: remote server(s) 1121, other device(s) 1122 (e.g., computers, laptops, tablets, mobile phones, etc.), remote data storage 1123, etc.

Computer 1110 can further include at least one processor 1115 (also referred to herein as a central processing units (CPU)). Optionally, each CPU 1115 can include a CPU cache. Each CPU 1115 can be configured to read and execute program instructions.

Computer 1110 can further include memory and, particularly, computer-readable storage mediums. The memory can include primary memory 1116 and secondary memory. Primary memory 1116 can include, but is not limited to, random access memory (RAM) (e.g., volatile memory employed during execution of program operations) and read only memory (ROM) (e.g., non-volatile memory employed during start-up). The RAM can include, but is not limited to, dynamic random access memory (DRAM), static random access memory (SRAM), or any other suitable type of RAM. The ROM can include, but is not limited to, erasable programmable read only memory (EPROM), flash memory, electronically erasable programmable read only memory (EEPROM), programmable read only memory (PROM), or any other suitable type of ROM. Secondary memory can be non-volatile. The secondary memory can include internal secondary memory 1117, such as internal solid state drive(s) (SSD(s)) and/or internal hard disk drive(s) (HDD(s), installed within the computer 1110 and connected to bus 1111. The secondary memory can also include external secondary memory connected to or otherwise in communication with computer 1110 (e.g., peripheral devices). The external secondary memory can include, for example, external/portable SSD(s), external/portable HDD(s), flash drive(s), thumb drives, compact disc(s) (CD(s)), digital video disc(s) (DVD(s)), network-attached storage (NAS), storage area network (SAN), or any other suitable non-transitory computer-readable storage media connected to or otherwise in communication with computer 1110. The different functions of primary and secondary memory are well known in the art and, thus, the details thereof have been omitted from this specification in order to allow the reader to focus on the salient aspects of the disclosed embodiments.

In some embodiments, program instructions for performing the disclosed method or a portion thereof, as described above, can be embodied in (e.g., stored in) secondary memory accessible by computer 1110. When the program instructions are to be executed (e.g., in response to user inputs to computer 1110), required information (e.g., the program instructions and other data) can be loaded into the primary memory (e.g., stored in RAM). CPU 1115 can read the program instructions and other data from the RAM and can execute the program instructions. In other embodiments, a client-server model can be employed. In this case, computer 1110 can be a client and a remote server 1121 in communication with computer 1110 over a network 1120 can provide, to the client, a service including execution of program instructions for performing the disclosed method or a portion thereof, as described above, in response to user inputs computer 1110.

It should be understood that the terminology used herein is for the purpose of describing the disclosed structures and methods and is not intended to be limiting. For example, as used herein, the singular forms “a,” “an,” and “the” are intended to include the plural forms as well, unless the context clearly indicates otherwise. Additionally, as used herein, the terms “comprises,” “comprising,” “includes,” and/or “including” specify the presence of stated features, integers, steps, operations, elements, and/or components, but do not preclude the presence or addition of one or more other features, integers, steps, operations, elements, components, and/or groups thereof. Furthermore, as used herein, terms such as “right,” “left,” “vertical,” “horizontal,” “top,” “bottom,” “upper,” “lower,” “under,” “below,” “underlying,” “over,” “overlying,” “parallel,” “perpendicular,” etc., are intended to describe relative locations as they are oriented and illustrated in the drawings (unless otherwise indicated) and terms such as “touching,” “in direct contact,” “abutting,” “directly adjacent to,” “immediately adjacent to,” etc., are intended to indicate that at least one element physically contacts another element (without other elements separating the described elements). The term “laterally” is used herein to describe the relative locations of elements and, more particularly, to indicate that an element is positioned to the side of another element as opposed to above or below the other element, as those elements are oriented and illustrated in the drawings. For example, an element that is positioned laterally adjacent to another element will be beside the other element, an element that is positioned laterally immediately adjacent to another element will be directly beside the other element, and an element that laterally surrounds another element will be adjacent to and border the outer sidewalls of the other element. The corresponding structures, materials, acts, and equivalents of all means or step plus function elements in the claims below are intended to include any structure, material, or act for performing the function in combination with other claimed elements as specifically claimed.

The method as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various disclosed embodiments have been presented for purposes of illustration but are not intended to be exhaustive or limiting. Many modifications and variations will be apparent to those of ordinary skill in the art without departing from the scope and spirit of the disclosed embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a processor; and
a storage medium readable by the processor, wherein the storage medium stores a program of instructions executable by the processor to cause the processor to perform a method, and wherein the method includes:
generating a regions database using a technology file for a specific processing technology and a design manual;
comparing an area of an integrated circuit layout to the regions database to identify specific integrated circuit component regions within the area; and
generating a digital illustration of the area including representations of the specific integrated circuit component regions.

2. The system of claim 1, wherein the digital illustration of the area further includes representations of dielectric material regions adjacent to the specific integrated circuit component regions.

3. The system of claim 2, wherein the representations of the specific integrated circuit component regions and the representations of the dielectric material regions include visual identifiers including any of different fill colors, different fill patterns, different line colors, different line weights, and different line dash patterns.

4. The system of claim 1, wherein the method further includes receiving, through a graphic user interface, selection inputs indicating at least the integrated circuit layout, a digital illustration type, and the area.

5. The system of claim 4, wherein the selection inputs include one of:
selection of a two-dimensional digital illustration and placement of a line over the integrated circuit layout to indicate the area; and
selection of a three-dimensional digital illustration and placement of a polygon shape over the integrated circuit layout to indicate the area.

6. The system of claim 5, wherein the polygon shape is parallelogram shape.

7. The system of claim 4, wherein the method includes any of: displaying the digital illustration through the graphic user interface; and storing the digital illustration in the storage medium.

8. The system of claim 7, wherein the method includes: generating multiple different digital illustrations of different areas of the integrated circuit layout; displaying the different digital illustrations through the graphic user interface; and storing the different digital illustrations in the storage medium.

9. The system of claim 2,
wherein the storage medium stores the technology file for the specific processing technology and the design manual, and
wherein the generating of the regions database includes:
accessing the technology file and the design manual;
parsing the technology file and the design manual to identify all processing layers in the specific processing technology including any overlapping layers and to further identify shapes corresponding to integrated circuit component regions and dielectric material regions created by the processing layers;
based on results of the parsing, generating the regions database including a list of the integrated circuit component regions and the dielectric material regions, wherein each region on the list is associated with at least one processing layer; and
storing the regions database in the storage medium.

10. The system of claim 9,
wherein the generating of the digital illustration further includes indicating, within the digital illustration, at least some of region heights.

11. A method comprising:
generating, by a processor, a regions database using a technology file for a specific processing technology and a design manual;
comparing, by the processor, an area of an integrated circuit layout to the regions database to identify specific integrated circuit component regions within the area; and
generating, by the processor, a digital illustration of the area including representations of the specific integrated circuit component regions.

12. The method of claim 11, wherein the digital illustration of the area further includes representations of dielectric material regions adjacent to the specific integrated circuit component regions.

13. The method of claim 12, wherein the representations of the specific integrated circuit component regions and the representations of the dielectric material regions include visual identifiers including any of different fill colors, different fill patterns, different line colors, different line weights, and different line dash patterns.

14. The method of claim 11, further comprising receiving, by the processor through a graphic user interface on a display, selection inputs indicating at least the integrated circuit layout, a digital illustration type, and the area.

15. The method of claim 14, wherein the selection inputs include one of:
selection of a two-dimensional digital illustration and placement of a line over the integrated circuit layout to indicate the area; and
selection of a three-dimensional digital illustration and placement of a polygon shape over the integrated circuit layout to indicate the area.

16. The method of claim 14, further comprising any of: displaying, by the processor, the digital illustration through the graphic user interface; and storing, by the processor, the digital illustration in the storage medium.

17. The method of claim 16, further comprising: generating, by the processor, multiple different digital illustrations of different areas of the integrated circuit layout; and storing, by the processor, the different digital illustrations in a storage medium.

18. The method of claim 12, wherein the generating of the regions database includes:
accessing the technology file and the design manual from a storage medium;
parsing the technology file and the design manual to identify all processing layers in the specific processing technology including any overlapping layers and to further identify shapes corresponding to integrated circuit component regions and dielectric material regions created by the processing layers;
based on results of the parsing, generating the regions database including a list of the integrated circuit component regions and the dielectric material regions, wherein each region on the list is associated with at least one processing layer; and
storing the regions database in the storage medium.

19. The method of claim 18,
wherein the generating of the digital illustration further includes indicating, within the digital illustration, at least some of region heights.

20. A computer program product comprising a computer readable storage medium having program instructions embodied therewith, wherein the program instructions are executable by a processor to cause the processor to perform a method and wherein the method comprises:
generating a regions database using a technology file for a specific processing technology and a design manual;
comparing an area of an integrated circuit layout to the regions database to identify specific integrated circuit component regions within the area; and
generating a digital illustration of the area, wherein the digital illustration includes representations of the specific integrated circuit component regions.
